(19) United States
(12) Patent Application Publication
(10) Pub. No.: US 2008/0310365 A1
(43) Pub. Date: Dec. 18, 2008

(54) METHOD AND SYSTEM FOR CACHING CONTENT ON-DEMAND IN A WIRELESS COMMUNICATION NETWORK

(76) Inventors: Mustafa Ergen, Oakland, CA (US); Rehan Jalil, San Jose, CA (US)

Correspondence Address: Global IP Services, PLLC, 198 F, 27th Cross, 3rd Block, Jayanagar, Bangalore, Karnataka,, 560011, IN

(21) Appl. No.: 11/937,507

(22) Filed: Nov. 9, 2007

Related U.S. Application Data
(60) Provisional application No. 60/934,197, filed on Jun. 12, 2007.

(51) Int. Cl. H04Q 7/00

(52) U.S. Cl. 370/331

(57) ABSTRACT

The present invention provides methods and systems for caching content in a wireless communication network. The method includes receiving a request for a content at a first base station from a mobile station. In response to receiving the request for the content, the first base station caches a first fragment of the content. The first fragment includes a plurality of packets. Further, the first base station transmits one or more packets of the plurality of packets corresponding to the first fragment to the mobile station. The method further includes initiating a handover of the mobile station to at least one second base station. The at least one base station caches a remaining plurality of packets corresponding to the first fragment of the content in response to the handover.

### RELATED APPLICATIONS

Benefit is claimed under 35 U.S.C. 119(e) to U.S. Provisional Applications Ser. 60/934,197, by Mustafa Ergen et al., filed on 11 Jun. 2007 which is herein incorporated in its entirety by reference for all purposes.

### FIELD OF THE INVENTION

The present invention is generally related to wireless communication networks, and more particularly, to on-demand partial caching in a wireless communication network.

### BACKGROUND OF THE INVENTION

Wireless communication networks are widely deployed to provide various types of communication such as voice, data, and so on, for a number of users. The wireless communication networks are typically based on code division multiple access systems (CDMA), time division multiple access (TDMA), frequency division multiple access (FDMA), or Orthogonal frequency division multiplexing (OFDM). For instance, Global system for mobile communications (GSM) is based on TDMA. Similarly, Worldwide Interoperability for Microwave Access (WiMAX), 3GPP Long term evolution and 3GPP2 Ultra Mobile Broadband is based on Orthogonal Frequency Division Multiplexing Access (OFDMA).

In a WiMAX communication network, a Mobile Access Service Network (MASN) forms the radio access network. The MASN refers to a set of network functions that provide connectivity services in form of Internet Protocol (IP) packets to mobile stations in the WiMAX network. Typically, the connectivity services include, but are not limited to, video streaming, vehicle tracking, file sharing and web browsing.

Typically, a wireless communication network includes a plurality of base stations, a plurality of mobile stations, one or more central controllers, one or more home agents and one or more content servers together with Authentication, Authorization, and Accounting (AAA), Dynamic Host Configuration Protocol (DHCP), Policy server, etc. A set of base stations is usually associated with a central controller. The central controller communicates with the associated base stations to provide various connectivity services and transmits data in form of IP packets. For instance, a mobile station may request for radio access from a base station. In response to the request, the base station may communicate with the central controller to receive the relevant IP packets. The central controller can fetch the IP packets from the home agent or the content server before transmitting the IP packets to the base station. Thereafter, the base station transmits the IP packets to the mobile station requesting the radio access. Additionally, in some configurations, central controller may include a radio related component and a data related component which may be located physically apart from each other. Thereby, an IP packet may be routed from the content server through three or more intermediate routing points: the home agent, the central controller and the base station before transmission to the mobile station.

A transmission link between two successive routing points in the wireless communication network has a transmission cost associated with it. Typically, a transmission link connecting the content server and the home agent has the least transmission cost. However, the transmission cost increases as the IP packet is transmitted from the content server through each of the routing points to the mobile station. Consequently, the transmission link between the base station and the central controller may have a higher cost associated with it as compared to the transmission link between the home agent and the central controller, which, in turn may have a higher cost associated with it as compared to the transmission link between the home agent and the content server.

A mobile station in the wireless communication network may frequently undergo handover from a first base station to a second base station as it moves from the current cell area to any of the neighboring cell areas. In the existing methods, during the handover, the mobile station stops receiving the content from the first base station and the mobile station tries to retrieve content from the second base station. Due to this, the second base station transmits one or more fragments of the content irrespective of content previously transmitted from the first base station. Consequently, the transmission cost associated with the link between the mobile station and the base station is not effectively optimized.

Additionally, the second base station may retrieve the requested content from the central controller, the home agent or the content server in entirety before transmitting the content to the mobile station. This may result in high transmission costs and may also cause the mobile station to experience a significant latency in receiving the content.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram showing an environment in which various embodiments of the present invention can function.

FIG. 2 is a flow diagram of a method for caching content in a wireless communication network, in accordance with an embodiment of the present invention.

FIG. 3 is a flow diagram of a method for initiating handover of a mobile station in a wireless communication network, in accordance to an embodiment of the present invention.

FIG. 4 is a block diagram of a system for caching content in a wireless communication network, in accordance with an embodiment of the present invention.

### DETAILED DESCRIPTION

As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a representative basis for teaching one skilled in the art to variously employ the present invention in virtually any appropriately detailed structure. Further, the terms and phrases used herein are not intended to be limiting but rather to provide an understandable description of the present invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

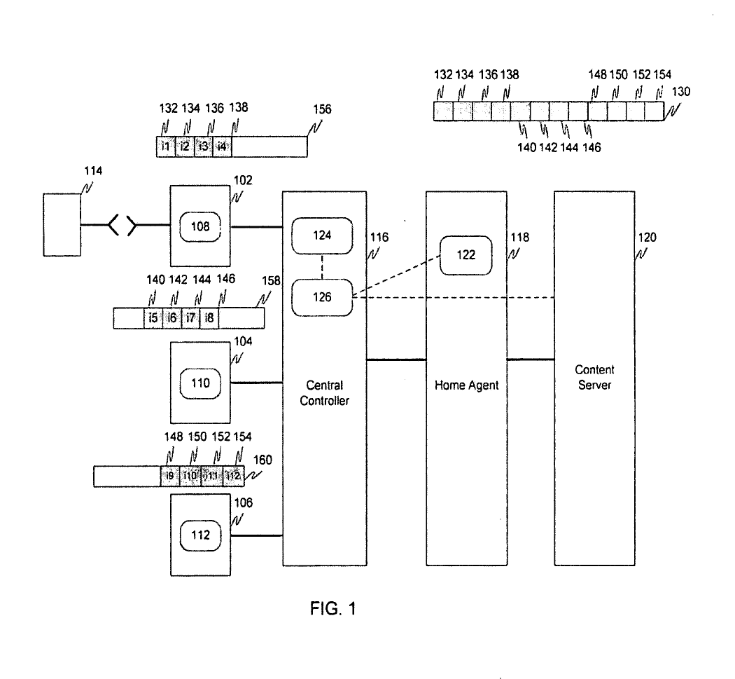

Generally speaking, pursuant to various embodiments, the present invention provides a method and system for caching content in a wireless communication network. The wireless communication network may be, but is not limited to, a Mobile Access Service Network (MASN). The wireless communication network includes a plurality of base stations and a plurality of mobile stations. At a given point in time, one or more mobile stations may be associated with one or more base stations in the wireless communication network. Specifically, a mobile station can establish communication in the wireless communication network by associating with a base station. Further, the mobile station may also request the base station for content. The present invention provides a method for caching content at one or more base stations, such that the transmission costs and the latency associated with acquiring the content are reduced. The method and system for caching content in the wireless communication network are explained in detail in conjunction with FIG. 1 to FIG. 5 below.

Referring now to drawings, and more specifically to FIG. 1, a block diagram of an environment 100 in which various embodiments of the present invention can function is shown. Environment 100 includes a base station 102, a base station 104 and a base station 106. It will be apparent to those skilled in the art that although FIG. 1 depicts only three base stations (base station 102, base station 104, and base station 106), environment 100 can include any number of base stations. The base stations in environment 100 provide connectivity services to one or more mobile stations in environment 100. The connectivity services here may be for example, but are not limited to, telephony, media streaming, location tracking, file sharing and web browsing.

In accordance with an embodiment of the present invention, a base station in the environment 100 may include a cache server. The cache server is used for caching content. For instance, as depicted in FIG. 1, base station 102 includes a cache server 108, base station 104 includes a cache server 110 and base station 106 includes a cache server 112.

Environment 100 further includes a plurality of mobile stations associated with base station 102, base station 104 or base station 106. One of the mobile stations associated with base station 102 is depicted as a mobile station 114. Mobile station 114 can be for example, a mobile phone, a laptop, a personal digital assistant (PDA), or any device which is compatible with the wireless communication network. Mobile station 114 is associated with base station 102 to receive and transmit IP packets.

Environment 100 can further include a central controller 116, a home agent 118, and a content server 120. Home agent 118 may include a cache server 122 for caching content retrieved from content server 120. Additionally, central controller 116 may also include a cache server 124 for caching content that may be retrieved from home agent 118 or from content server 120. In an embodiment, central controller 116 may further include a caching controller 126 for controlling cache server 124. In an embodiment of the present invention, caching controller 126 may be located outside central controller 116.

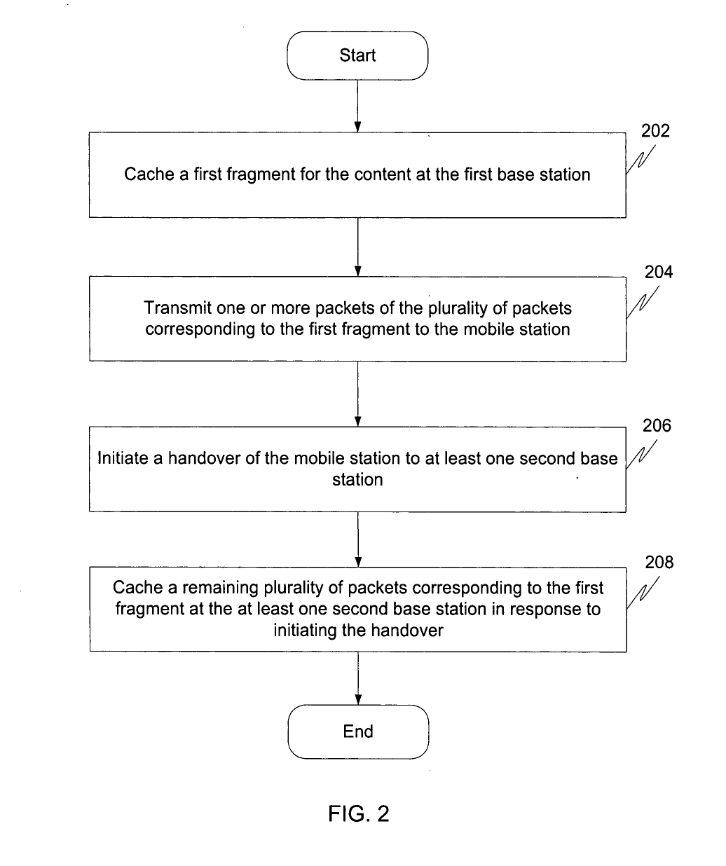

In an embodiment of the present invention, mobile station 114 may request base station 102 for content. For instance, mobile station 114 may request for or may be subscribed to receive media content. In accordance with the present invention, upon receiving the request, base station 102 may retrieve one or more fragments of the content from one or more of central controller 116, home agent 118 and content server 120. The one or more fragments of the content may be cached in cache server 108. In an embodiment, one or more fragments of the content may also be cached at base station 104 or base station 106, upon receiving the request. The method of caching one or more fragments of the content in base station 102, base station 104 and base station 106 is explained in detail in conjunction with FIG. 2 to FIG. 4 below.

Turning now to FIG. 2, a flow diagram of a method for caching content in a wireless communication network is shown, in accordance with an embodiment of the present invention. As depicted in FIG. 1, mobile station 114 is associated with base station 102, which provides connectivity services to mobile station 114.

Base station 102 receives a request for content from mobile station 114. For instance, mobile station 114 may request base station 102 for streaming of media content. Alternately, mobile station 114 may be a subscriber of a streaming service that streams content to mobile station 114, without receiving any request for the content. In accordance with the present invention, the content is partitioned into one or more fragments. The content may be partitioned at any one of content server 120, home agent 118, or central controller 116. The content may be for example, but not limited to at least one of a media file, a text file, an HTML file, a binary file, a compressed file, an ASCII file and a web content. In response to receiving the request, base station 102 checks cache server 108 to determine if a first fragment of the content requested by mobile station 114 is present. The first fragment of the content may include a plurality of packets of the content. If the first fragment of the content is present in cache server 108, base station 102 transmits the first fragment of the content to mobile station 114.

If the first fragment of the content requested by mobile station 114 is not present in cache server 108, base station 102 may retrieve at least the first fragment of the content from one or more of central controller 116, home agent 118 and content server 120. That is, base station 102 may retrieve the first fragment of the content “on-demand”. The first fragment of the content can then be cached in cache server 108, at step 202. For instance, referring back to FIG. 1, content 130 includes a packet 132, a packet 134, a packet 136, a packet 138, a packet 140, a packet 142, a packet 144, a packet 146, a packet 148, a packet 150, a packet 152 and a packet 154. It will be apparent to those skilled in the art that content 130 can include any number of packets. However, only twelve packets are depicted in FIG. 1 for the sake of clarity.

When the request for content 130 is received at base station 102, a first fragment 156 of content 130 is cached at cache server 108. First fragment 156 includes a plurality of packets of content 130. In accordance with FIG. 1, the plurality of packets of first fragment 156 includes packet 132, packet 134, packet 136 and packet 138. In an embodiment of the present invention, base station 102 may retrieve first fragment 156 from cache server 124. If first fragment 156 is absent at cache server 124, caching controller 126 may, in turn request cache server 122 of home agent 118 for first fragment 156. If first fragment 156 is available on cache server 122, caching controller 126 retrieves first fragment 156 and transmits it to base station 102. Additionally, caching controller 126 may cache first fragment 156 in cache server 122.

However, if first fragment 156 is not present on cache server 122, caching controller 126 may request content server 120 for first fragment 156. Thereby, first fragment 156 may be routed through the intermediate routing points, but not limited to, home agent 118, central controller 116, and base station 102 before transmission to mobile station 114.

In response to caching first fragment 156, base station 102 may assign a first plurality of indices to the plurality of packets of first fragment 156. An index assigned by base station 102 to a packet of first fragment 156 corresponds to a sequence number of the packet in content 130. For instance, base station 102 caches packet 132 and assigns an index ‘i1’ to packet 132. Similarly, base station 102 caches packet 134, packet 136 and packet 138 and assigns an index ‘i2’, and index ‘i3’ and index ‘i4’ to packet 134, packet 136 and packet 138 respectively.

Thereafter, at step 204, base station 102 transmits one or more packets of the plurality of packets corresponding to first fragment 156 to mobile station 114. For instance, the one or more packets of the plurality of packets corresponding to first fragment 156 may include packet 132 and packet 134. However, before base station 102 can transmit packet 136 and packet 138, mobile station 114 may roam from a cell area of base station 102 to a neighboring cell area. The neighboring cell area may be covered by at least one second base station. The at least one base station may include base station 104. While roaming, mobile station 114 may dissociate from base station 102 and associate with base station 104. This process is known in the art as a “handover”. Thus, mobile station 114 undergoes a handover from base station 102 to base station 104.

Upon identifying the movement of mobile station 114 to the cell area of base station 104, base station 102 initiates a handover of mobile station 114 to base station 104 at step 206.

In response to initiating the handover, base station 102 stops caching of remaining portion of first fragment 156, if any. Thereby, base station 102 caches content 130 partially only as long as there is a demand for content 130 from mobile station 114. Base station 102 stops the caching of the remaining fragments of content 130 upon the initiation of the handover of mobile station 114.

Further, during the initiation of the handover, base station 102 can tag the one or more packets of the plurality of packets corresponding to first fragment 156 transmitted to mobile station 114 using a tag index. The tag index corresponds to an index of a last packet of the one or more packets transmitted to mobile station 114. For instance, base station 102 can mark a tag index to index ‘i2’ corresponding to packet 134, if packet 132 and packet 134 are transmitted to mobile station 114 before the initiation of the handover.

Thereafter, base station 102 transmits the tag index to central controller 116 or directly to base station 104. In the embodiment in which the tag index is transmitted to central controller 116, central controller 116 can forward the tag index to base station 104.

Upon receiving the tag index of the last packet transmitted by base station 102, base station 104 can determine a remaining plurality of packets corresponding to first fragment 156, which is not transmitted to mobile station 114. For instance, base station 104 receives index ‘i2’ from base station 102. Base station 104 uses the index ‘i2’ corresponding to packet 134 to identify the remaining plurality of packets corresponding to first fragment 156 subsequent to packet 134 in first fragment 156. Base station 104 then at step 208 only caches the remaining plurality of packets corresponding to first fragment 156, which are not transmitted to mobile station 114 by base station 102. Base station 104 can retrieve packet 136 and packet 138 of first fragment 156 from cache server 124 of central controller 116, cache server 122 of home agent 118 or from content server 120. In an embodiment, base station 104 can retrieve packet 136 and packet 138 directly from base station 102. Thereby, base station 104 caches first fragment 156 partially and does not cache the one or more packets of the plurality of packets corresponding to first fragment 156 that are already transmitted to mobile station 114. Those skilled in the art will appreciate that this partial, on-demand caching of content reduces the latency involved in transmitting the one or more second packets to mobile station 114 and the transmission cost of the communication link between mobile station 114 and base station 104.

Further, in an embodiment of the present invention, central controller 116 or home agent 118 may determine that the probability that mobile station 114 is associated with base station 104 for more than a threshold time period is high. The determination can be made based on, for instance, but not limited to, an estimated trajectory of the mobile station, signal strength from mobile station 114 and/or a historical data of at least one of mobile station 114, base station 102 and base station 104.

Based on the determination, base station 104 can cache a second fragment 158 of content 130 at cache server 110, while the remaining plurality of packets corresponding to first fragment 156, namely packet 136 and packet 138, of first fragment 156 are being transmitted to mobile station 114. Second fragment 158 includes a plurality of packets subsequent to the plurality of packets corresponding to first fragment 156 in content 130. Hence, base station 104 can cache packet 140, packet 142, packet 144 and packet 146 of second fragment 158 in cache server 110.

Further, base station 104 assigns a second plurality of indices to the plurality of packets of second fragment 158. For instance, base station 104 caches packet 140 and assigns an index ‘i5’ to packet 140. Similarly, base station 104 caches packet 142 and assigns an index ‘i6’ to packet 142, caches packet 144 and assigns an index ‘i7’ to packet 144, and caches packet 146 and assigns an index ‘i8’ to packet 146. Base station 104 may retrieve second fragment 158 from one or more of cache server 122, cache server 126 and content server 120, if second fragment 158 is absent in cache server 110 of base station 104.

In an embodiment of the present invention, central controller 116 may identify an area in which mobile station 114 may roam for a predetermined time period. For instance, central controller 116 may identify base station 102, base station 104 and base station 106 based on an estimated trajectory of mobile station 114. The estimated trajectory may indicate the cell areas that can be visited by mobile station 114, which may be predicted, based on previously visited cell areas by mobile station 114. The base stations may also be identified based on a historical data of mobile station 114, the base station 102, base station 104 and/or the base station 106. For instance, historical data of mobile station 114 may identify one or more probable cell areas adjacent to the cell area of base station 102 which mobile station 114 may visit.

Central controller 116 may then determine one or more base stations in the one or more probable cell areas. After receiving the request for content 130 from mobile station 114 at base station 102, central controller 116 may proactively distribute fragments of content 130 to the one or more base stations based on, but not limited to, the estimated trajectory of mobile station 114, signal strength from mobile station 114 and/or a historical data of at least one of mobile station 114, base station 102 and base station 104.

Consequently, central controller 116 may, for instance, transmit first fragment 156 to cache server 108 of base station 102, second fragment 158 to cache server 110 of base station 104 and a third fragment 160 to cache server 112 of base station 106. Third fragment 160 is subsequent to second fragment 158 in content 130. Hence, base station 106 can cache packet 148, packet 150, packet 152 and packet 154.

When mobile station 114 moves into a cell area of base station 106, third fragment 160 can be transmitted to mobile station 114. Alternately, if mobile station 114 requires other fragments of content 130 from base station 106, then the other fragments or partial fragments of content 130 may be retrieved from other base stations, central controller 116, home agent 118 or content server 120.

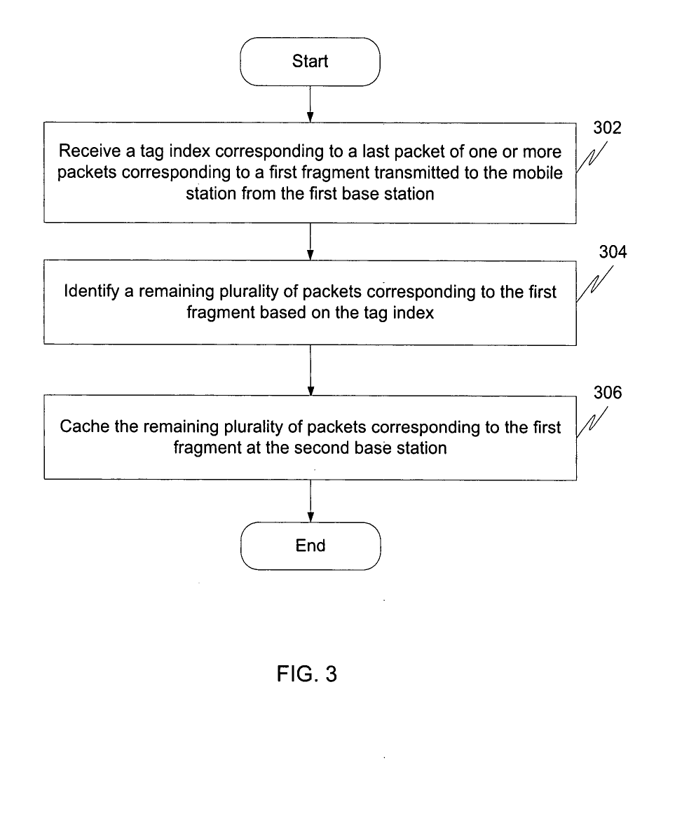

FIG. 3 is a flow diagram of a method for initiating handover of a mobile station in a wireless communication network, in accordance to an embodiment of the present invention. As described in conjunction with FIG. 2, base station 102 receives a request for content 130 from mobile station 114. Thereafter, base station retrieves and caches first fragment 156 of content 130. Further, base station 102 indexes the plurality of packets of first fragment 156. Base station 102 transmits the one or more packets of the plurality of packets corresponding to first fragment 156 to mobile station 114. For instance, the one or more packets of the plurality of packets corresponding to first fragment 156 include packet 132 and packet 134. Thereafter, base station 102 identifies movement of mobile station 114 from the cell area of base station 102 to the cell area of base station 104. Upon identifying the movement of mobile station 114 to cell area of base station 104, base station 102 initiates the handover of mobile station 114 to base station 104.

During the initiation of the handover, base station 102 tags the one or more packets of the plurality of packets corresponding to first fragment 156 transmitted to mobile station 114 using a tag index. Subsequently, base station 102 may transmit the tag index directly to base station 104 or to central controller 116. In the embodiment in which the tag index is transmitted to central controller 116, central controller 116 can forward the tag index to base station 104.

Referring back to FIG. 3, base station 104 receives the tag index from base station 102 at step 302. As mentioned earlier, the tag index may correspond to an index of a last packet transmitted to mobile station 114. For instance, base station 102 mark a tag index to index ‘i2’ corresponding to packet 134, as packet 134 is the last packet transmitted to mobile station 114 before the initiation of the handover.

Those skilled in the art will realize that the packets already transmitted to mobile station 114 may be identified by methods other than tag indices, and all such methods are within the scope of the present invention.

Upon receiving the tag index, base station 104 identifies, at step 304, the remaining plurality of packets corresponding to first fragment 156, which is not transmitted to mobile station 114, based on the tag index. The remaining plurality of packets corresponding to first fragment 156 includes one or more packets subsequent to packet 134 in first fragment 156. Base station 104 uses the index ‘i2’ corresponding to packet 134 to identify the one or more packets subsequent to packet 134 in first fragment 156. Referring back to FIG. 1, the one or more packets identified by base station 104 include packet 136 and packet 138.

Subsequently at step 306, base station 104 caches the remaining plurality of packets corresponding to first fragment 156. Base station 104 can retrieve packet 136 and packet 138 of first fragment 156 from cache server 124 of central controller 116, cache server 122 of home agent 118 or from content server 120. In an embodiment, base station 104 can retrieve packet 136 and packet 138 directly from base station 102. Thereby, base station 104 caches first fragment 156 partially and does not cache the one or more packets of the plurality of packets corresponding to first fragment 156 that are already transmitted to mobile station 114 by base station 102. This helps lower the latency of transmission to mobile station 114, and may also reduce the transmission cost of a communication link between base station 104 and mobile station 114.

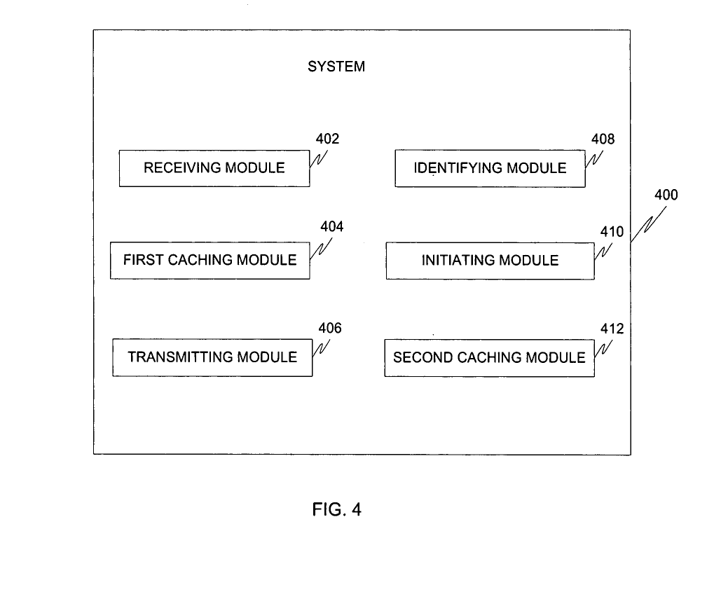

Turning now to FIG. 4, a block diagram of a system 400 for caching content in a wireless communication network is shown, in accordance with an embodiment of the present invention. System 400 includes a receiving module 402 and a first caching module 404. Receiving module 402 and first caching module 404 may be located in, for instance, base station 102. In an embodiment of the present invention, first caching module 404 is the same as cache server 108 of base station 102.

Initially, receiving module 402 receives a request for content from mobile station 114. For instance, mobile station 114 may be a mobile station located in cell area of base station 102. Mobile station 114 may request receiving module 402 for streaming of media content. Alternatively, mobile station 114 may be a subscriber of streaming service, which streams content to mobile station 114, without receiving any request for the content. In accordance with the present invention, the content is partitioned into one or more fragments. The content may be partitioned at any one of content server 120, home agent 118, or central controller 116. The content may be for example, but not limited to at least one of a media file, a text file, a binary file, an ASCII file, an HTML file, a binary file, a compressed file, an ASCII file and a web content.

The content may be located at content server 120. However, one or more packets of the content may also be cached at cache server 124 of central controller 116, cache server 122 of home agent 118, cache server 108 of base station 102, cache server 110 of base station 104 and/or cache server 112 of base station 106. Mobile station 114 may, for instance, request for content 130. Content 130 includes packet 132, packet 134, packet 136, packet 138, packet 140, packet 142, packet 144, packet 146, packet 148, packet 150, packet 152, and packet 154.

In response to receiving the request from mobile station 114, first caching module 404 determines if first fragment 156 of content 130 is already present in cache server 108. First fragment 156 of content 130 may include a plurality of packets of content 130. If first fragment 156 of the content is present in cache server 108, a transmitting module 406, which may be located in base station 102, starts transmitting first fragment 156 to mobile station 114.

If first fragment 156 of content 130 is not present in cache server 108, first caching module 404 may retrieve at least first fragment 156 of content 130 from any one of central controller 116, home agent 118 and content server 120. That is, first caching module 404 may retrieve first fragment 156 of content “on-demand”. First caching module 404 caches the plurality of packets of first fragment 156 in cache server 108. First fragment 156 includes packet 132, packet 134, packet 136 and packet 138.

In response to caching first fragment 156, first caching module 404 may assign a first plurality of indices to the plurality of packets of first fragment 156. An index assigned by first caching module 404 to a packet of first fragment 156 can correspond to a sequence number of the packet in content 130. For instance, first caching module 404 caches packet 132 and assigns an index ‘i1’ to packet 132. Similarly, first caching module 404 caches packet 134, packet 136 and packet 138 and assigns an index ‘i2’, and index ‘i3’ and index ‘i4’ to packet 134, packet 136 and packet 138 respectively. However, embodiments of the present invention may use any other method of indexing.

In response to first caching module 404 caching first fragment 156, transmitting module 406 transmits one or more packets of the plurality of packets corresponding to first fragment 156 to mobile station 114. For instance, the one or more packets of the plurality of packets corresponding to first fragment 156 may include packet 132 and packet 134. However, before transmitting module 406 can transmit packet 136 and packet 138, mobile station 114 may move from a cell area of base station 102 to a cell area of base station 104.

An initiating module 408 initiates a handover of mobile station 114 from base station 102 to base station 104, upon detecting the movement of mobile station 114. In response to initiating the handover, first caching module 404 can stop caching of remaining portion of first fragment 156, if any. Thereby, first caching module 404 caches content 130 partially only as long as there is a demand for content 130 from mobile station 114. Further during the initiation of the handover, first caching module 404 can tag the one or more packets of the plurality of packets corresponding to first fragment 156 transmitted to mobile station 114 using a tag index. The tag index may correspond to an index of a last packet transmitted to mobile station 114. For instance, first caching module 404 can mark a tag index to index ‘i2’ corresponding to packet 134, if packet 132 and packet 134 are transmitted to mobile station 114 before the initiation of the handover.

Thereafter, transmitting module 406 can transmit the tag index to central controller 116 or directly to base station 104. In the embodiment in which the tag index is transmitted to central control 116, central controller 116 can forward the tag index to the base station 104.

Upon receiving the tag index of the last packet transmitted by transmitting module 406, a second caching module 412, which may be the same as cache server 110 of base station 104, determines a remaining plurality of packets corresponding to first fragment 156, which is not transmitted to mobile station 114. The remaining plurality of packets corresponding to first fragment 156 includes one or more packets subsequent to the last packet transmitted to mobile station 114 by transmitting module 406. For instance, second caching module 412 receives index ‘i2’ from transmitting module 406. Second caching module 412 uses the index ‘i2’ corresponding to packet 134 to identify one or more packets subsequent to packet 134 in first fragment 156. Second caching module 412 can, then, only cache the remaining plurality of packets corresponding to first fragment 156, which are not transmitted to mobile station 114 by transmitting module 406. Second caching module 412 can retrieve packet 136 and packet 138 of first fragment 156 from cache server 124 of central controller 116, cache server 122 of home agent 118 or from content server 120. In an embodiment, second caching module 412 can retrieve packet 136 and packet 138 directly from base station 102. Thereby, second caching module 412 caches the first fragment 156 partially and does not cache the one or more first packets of first fragment 156 that are already transmitted to mobile station 114. This enables reduction of transmission cost of the communication link between mobile station 114 and base station 104.

System 400 can further include an identifying module 408 for identifying one or more neighboring base stations of base station 102. For instance, base station 104 can be one of the neighboring base stations of base station 102.

Further, in an embodiment of the present invention, identifying module 408 may determine a probability of mobile station 114 being associated with a base station for more than a threshold time period. The probability can be determined based on, for instance, but not limited to, an estimated trajectory of the mobile station, signal strength from mobile station 114 and/or a historical data of at least one of mobile station 114, base station 102 and base station 104.

If the probability of mobile station 114 being associated with base station 104 for at least the threshold time period is high, second caching module 412 can also cache a second fragment 158 of content 130 at cache server 110, while the remaining plurality of packets corresponding to first fragment 156 are being transmitted to mobile station 114. Second fragment 158 is subsequent to first fragment 156 in content 130. Hence, second caching module 412 can cache packet 140, packet 142, packet 144 and packet 146 of second fragment 158 in cache server 110.

Further, second caching module 412 assigns a second plurality of indices to a plurality of packets of second fragment 158. For instance, second caching module 412 caches packet 140 and assigns an index ‘i5’ to packet 140. Similarly, second caching module 412 caches packet 142 and assigns an index ‘i6’ to packet 142, caches packet 144 and assigns an index ‘i7’ to packet 144, and caches packet 146 and assigns an index ‘i8’ to packet 146. Second caching module 412 may retrieve second fragment 158 from at least one of cache server 122, cache server 126 and content server 120, if second fragment 158 is absent in cache server 110 of base station 104.

In an embodiment of the present invention, identifying module 408 may identify an area in which mobile station 114 may roam for a predetermined time period. For instance, identifying module 408 may identify base station 102, base station 104 and base station 106 based on an estimated trajectory of mobile station 114. The estimated trajectory may indicate the cell areas to be visited by mobile station 114, which may be predicted based on previously visited cell areas by mobile station 114. Identifying module 408 may, also, identify the base stations based on a historical data of mobile station 114, the base station 102, base station 104 and/or the base station 106. For instance, identifying module 408 may use historical data of mobile station 114 to identify one or more probable cell areas adjacent to the cell area of base station 102 which mobile station 114 may visit.

Identifying module 408 may, then, determine one or more base stations in the one or more probable cell areas. In an embodiment of the present invention, after receiving the request for content 130 from mobile station 114 at base station 102, identifying module 408 may communicate with central controller 116, which, in turn, may proactively distribute fragments of content 130 to the one or more base stations based on, but not limited to, the estimated trajectory of mobile station 114, signal strength from mobile station 114 and/or a historical data of at least one of mobile station 114, base station 102 and base station 104. For instance, central controller 116 may transmit first fragment 156 to cache server 108 of base station 102, second fragment 158 to cache server 110 of base station 104, and third fragment 160 to cache server 112 of base station 106. This on-demand partial content caching at base stations in the wireless communication network facilitates reduction of transmission costs. Further, the partial content may also be cached at cache server 124 of central controller 116 and/or cache server 122 of home agent 118. This obviates the need to retrieve content 130 from content server 120, each time a request for content 130 is received at a base station.

Various embodiments of the present invention provide a method and system for on-demand, partial content caching in a wireless communication network. Further, the various embodiments of the present invention provide methods and system for optimizing transmission cost in the wireless communication network. In addition, the various embodiments of the present invention provide a method and system for reducing latency in the wireless communication network.

1. A method for caching content in a wireless communication network, the method comprising:
caching a first fragment of a content at a first base station, wherein the first fragment comprises a plurality of packets;
transmitting one or more packets of the plurality of packets corresponding to the first fragment to a mobile station;
initiating a handover of the mobile station to at least one second base station; and
caching a remaining plurality of packets corresponding to the first fragment at the at least one second base station in response to initiating the handover.

2. The method of claim 1 further comprises caching a second fragment of the content at the at least one second base station in response to initiating the handover, wherein the second fragment comprises a plurality of packets subsequent to the plurality of packets corresponding to the first fragment in the content.

3. The method of claim 1, wherein caching the first fragment of the content at the first base station comprises assigning a first plurality of indices to the plurality of packets corresponding to the first fragment, wherein an index of a packet corresponds to a sequence number of the packet in the plurality of packets.

4. The method of claim 3, wherein the initiating step comprises:
tagging the one or more packets of the plurality of packets corresponding to the first fragment transmitted to the mobile station; and
conveying a tag index to at least one of the at least one second base station and a central controller, wherein the tag index corresponds to an index of a last packet of the one or more packets of the plurality of packets corresponding to the first fragment transmitted to the mobile station.

5. The method of claim 4, wherein the remaining plurality of packets corresponding to the first fragment subsequent to the one or more packets of the plurality of packets is identified based on the tag index.

6. The method of claim 1, wherein the first fragment of the content is retrieved from at least one of a central controller and a content server, if the first fragment is absent at the first base station.

7. The method of claim 1, wherein the remaining plurality of packets corresponding to the first fragment is retrieved from at least one of a central controller, a content server and the first base station, if the remaining plurality of packets corresponding to the first fragment is absent at the at least one second base station.

8. The method of claim 1, wherein the initiating step comprises stopping caching of the content at the first base station.

9. The method of claim 1, wherein the at least one second base station is identified based on at least one of an estimated trajectory of the mobile station and a historical data of at least one of the mobile station, the first base station and the at least one second base station.

10. The method of claim 1, wherein the content comprises at least one of a media file, a text file, a binary file, an ASCII file, an HTML file and a web content.

11. A method of initiating a handover of a mobile station from a first base station to a second base station, the first base station transmitting a content to the mobile station, the method comprising:
receiving a tag index corresponding to a last packet of one or more packets of a plurality of packets corresponding to a first fragment transmitted to the mobile station from the first base station;
identifying a remaining plurality of packets corresponding to the first fragment based on the tag index, wherein the remaining plurality of packets corresponding to the first fragment is subsequent to the one or more packets in the first fragment; and
caching the remaining plurality of packets corresponding to the first fragment at the second base station.

12. A system for caching content in a wireless communication network, the system comprising:
a first caching module, the first caching module configured to cache a first fragment of a content at a first base station, wherein the first fragment comprises a plurality of packets;
a transmitting module, the transmitting module configured to transmit one or more packets of the plurality of packets corresponding to the first fragment to the mobile station;
an initiating module, the initiating module configured to initiate a handover of the mobile station to at least one second base station; and
a second caching module, the second caching module configured to cache a remaining plurality of packets corresponding to the first fragment at the at least one second base station in response to the initiating module initiating the handover.

13. The system of claim 12, wherein the second caching module is further configured to cache a second fragment of the content at the at least one second base station in response to the initiating module initiating the handover, wherein the second fragment comprises a plurality of packets subsequent to the plurality of packets corresponding to the first fragment in the content.

14. The system of claim 12, wherein the first caching module is further configured to assign a first plurality of indices to the plurality of packets corresponding to the first fragment, wherein an index of a packet corresponds to a sequence number of the packet in the plurality of packets corresponding to the first fragment.

15. The system of claim 14, wherein the first caching module is further configured to tag the one or more packets of the plurality of packets corresponding to the first fragment transmitted to the mobile station by the transmitting module.

16. The system of claim 15, wherein, in response to the initiating module initiating the handover, the transmitting module is further configured to convey a tag index to at least one of the at least one second base station and a central controller, wherein the tag index corresponds to an index of a last packet of the one or more packets of the plurality of packets corresponding to the first fragment transmitted to the mobile station.

17. The system of claim 16, wherein at least one of the second caching module and the central controller is configured to identify the remaining plurality of packets subsequent to the one or more packets corresponding to the first fragment based on the tag index.

18. The system of claim 12, wherein the first caching module is configured to retrieve the first fragment of the content from at least one of a central controller and a content server, if the first fragment is absent at the first caching module.

19. The system of claim 12, wherein the second caching module is configured to retrieve the remaining plurality of packets corresponding to the first fragment from at least one of a central controller, a content server and the first caching module, if the remaining plurality of packets corresponding to the first fragment is absent at the at least one second caching module.

20. The system of claim 12, wherein the first caching module is further configured to stop caching the content at the first base station in response to the initiating module initiating the handover of the mobile station to the at least one second base station.

21. The system of claim 12, wherein the system further comprises an identifying module, the identifying module configured to identify the at least one second base station based on at least one of an estimated trajectory of the mobile station and a historical data of at least one of the mobile station, the first base station and the at least one second base station.
